(19) United States
(12) Patent Application Publication
(10) Pub. No.: US 2011/0006512 A1
(43) Pub. Date: Jan. 13, 2011

(54) Protective Cable Cover

(76) Inventors: Jody James, Pearland, TX (US); Roy Torrance, Houston, TX (US)

Correspondence Address: LAW OFFICE OF DAVID MCEWING, P.O. BOX 70410, HOUSTON, TX, 77270, US

(21) Appl. No.: 12/501,963

(22) Filed: Jul. 13, 2009

(51) Int. Cl. F16L 55/00

(52) U.S. Cl. 285/45

(57) ABSTRACT

The protective cover disclosed in this application is used in oil and gas production wells. It may be used in other types of wells or in other industrial application utilizing piping and capillary tubes, signal or electrical power cables. Multiple capillary tubes, jacketed tubes and signal or power cables extend from the well head down into the well bore. The cables and tubes run on the outside of the production piping and inside the well casing. The protective cover comprises cast metal wherein the length of the cover is oriented parallel to the longitudinal axis of at least two pipe segments and a connector collar. The cover comprises 2 sides and a top thereby creating an interior channel. Each end of the channel is open. The cable(s) or tube(s) may enter the protective cover from one open end, continue within the channel under the cast metal top, and exit from the opposite open end of the protective cover. The cover is dimensioned to fit over the collar of the pipe connector, and the cover is attached to the shoulder or upset of the production pipe with bands, e.g., metal, surrounding the shoulder of the production pipe.

### BACKGROUND OF DISCLOSURE

1. Field of Use

The protective covers subject of this disclosure are fabricated from cast metal such as cast carbon steel and utilized in protecting downhole cables and tubes from damage primarily resulting from impact between the production piping and the well casing.

2. Related Art

Existing protective covers are fabricated from stamped steel and designed to be attached on a specified pipe size, thereby requiring the operator to maintain an inventory of covers for differing pipe diameters.

### SUMMARY OF DISCLOSURE

A protective cover comprising a cast metal wherein the length of the cover is oriented parallel to the longitudinal axis of at least two pipe segments and a pipe connector. The pipe may be downhole production pipe installed within a well casing. Electrical or fiber optic cables or capillary tubes may run along the outside of the production pipe. These cables or tubes need protection in placement over a pipe connector having an expanded diameter. The protective cover subject of this disclosure comprises 2 sides and a top thereby creating an interior channel. Each end of the channel is open. Cable(s) or tube(s) may enter the protective cover from one open end, continue within the channel under the cast steel top, and exit from the opposite open end of the protective cover. The cover is dimensioned to fit over the collar of the pipe connector, and the cover is attached to the shoulder or upset (hereinafter “upset”) of the production pipe with bands, e.g., metal, surrounding the upset of the production pipe.

### SUMMARY OF DRAWINGS

The accompanying drawings, which are incorporated in and constitute a part of the specification, illustrate preferred embodiments of the invention. These drawings, together with the general description of the invention given above and the detailed description of the preferred embodiments given below, serve to explain the principles of the invention.

FIG. 1 illustrates a multi-piece connection between the ends of two pieces of production piping. Illustrated are the ends of two pieces of production tubing and the central connector collar.

FIG. 2 illustrates the prior art protective cover fitting over the pipe connector and the production piping upset. The cover is attached to the production pipe with bands surrounding the pipe.

FIG. 3 illustrates the protective cover of the instant disclosure fitting onto the top of the pipe connector and attached to the pipe upset.

### DETAILED DESCRIPTION OF DISCLOSURE

The protective cover disclosed in this application is used in oil and gas production wells. It may be used in other types of wells or in other industrial application utilizing piping and capillary tubes, signal or electrical power cables. Multiple capillary tubes, jacketed tubes and signal or power cables extend from the well head down into the well bore. The cables and tubes run on the outside of the production piping and inside the well casing. In some applications, the cable or tubes are installed on the exterior of the well casing and inside the drilled hole.

The cables or tubes may be jacketed but additional protection is needed, particularly where the diameter of the production piping increases at a coupling connection. The standard production pipe diameter may be 2⅜″, 2⅞″, 3½″, 4″, 4½″. Production pipe may be in other sizes. The production piping is comprised of multiple pipe segments joined together with connector collars, thereby creating long lengths of continuously connected pipe.

It is at the connection that the production pipe has an upset and the diameter is the greatest. The upset is an expanded outer diameter of the production pipe. It is also referred to as the pipe shoulder. The cables and tubes traveling over the connection collars may be in close proximity to the steel well casing. Hence protective covers are installed at the coupling connections.

The covers protect the cable or tube against impact with the well casing as the production piping is removed and installed through the well casing. The cable and tubes extend through the open ends of the protective covers. The cable and tube are protected by the top and sides of the protective cover. The protective cover and the tube or cable can be secured to the shoulders of the production pipe with bands surrounding the shoulders at the top and bottom of the cover.

The prior art covers are made from stamped steel or similar metal. The prior art covers are designed so that the cover attaches to the production pipe of standard diameter, i.e., 2⅜″, 2⅞″, 3½″, 4″, 4½″. This point of contact is made at the pipe extending from both ends of the pipe connector and past the shoulder. This design requires an inventory be maintained of covers fitting each separate production pipe size. This is required because the protective cover fits closely to the surface of the connector collar and also extends to the surface of the production pipe where it attaches to the production pipe. Different covers are required for different sizes of production pipe. Different attaching bands are also required for the different diameter production pipes. The prior art cover is attached to the production pipe by metal bands that wrap around the circumference of the production pipe.

The prior art cover is fabricated from stamped steel or similar material. The stamped steel is typically rated to a crush strength of 15,000 lbs/sq. inch.

The protective cover taught by this disclosure is shorter than the prior art cover. The disclosed cover (hereinafter the “cover”) spans across the connector collar and rests on the upset section of the production pipe where the pipe diameter is the greatest and contain the thickest walls. This is advantageous as the upset section can withstand greater crushing impact than the other section of the production pipe. The diameter of the pipe upset may be more standardized among the differing diameter production pipes. This may be required to connect the pipe sections to a standardized connector collar.

Further, a single sized cover can be utilized at a connection regardless of the size, e.g., diameter, of the production pipe. Therefore it is not necessary to maintain an inventory of covers or attaching bands.

The cover comprises cast carbon steel. The cover is rated to a crush strength of 60,000 lbs/sq. inch. In addition, the pipe upset on which the cover rests comprises the thickest walls of the connector system for the production piping. The system comprises the connector collar, the pipe upset and the production pipe.

The cover may incorporate multiple side slots to accommodate variable sized or number of cables. The tubes or cables may fit under the encircling bands threaded through the slots of each cover side. The covers also may be of variable width, with variable width end openings, to accommodate variable sized or number of cables or tubes. The cables or tubes traverse through the cover in a channel formed from the three sides of the cover. The channel comprises the two sides and the cover top. This structure forms a channel through which the cable or tubes pass. The cable or tubes exit the cover through the open ends of the cover. The bottom of the two sides form a base on which the cover rests on the production pipe upset.

The cable or tubes exiting the cover may be formed to closely fit to the contours of the connector collar, the pipe upset and reduced diameter of the production pipe.

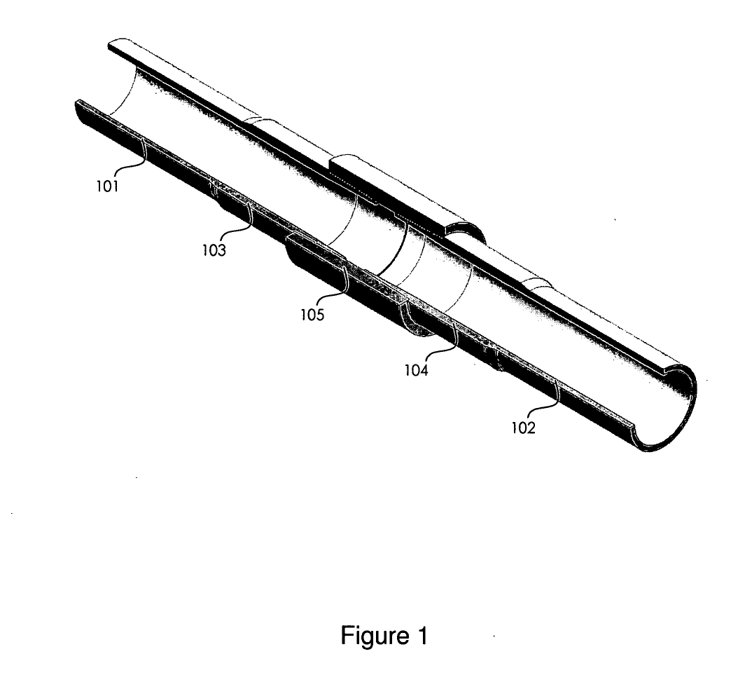

Turning to the drawings, FIG. 1 illustrates a cut away view of the connection components consisting of the two production pipes 101, 102 with partially threaded upsets 103, 104 joined together by the internally threaded connector collar 105. The middle connector collar 105 completes the connection. The unthreaded sections of the upset production pipe 103, 104 have the greatest thickness. The connector collar 105 has the greatest diameter.

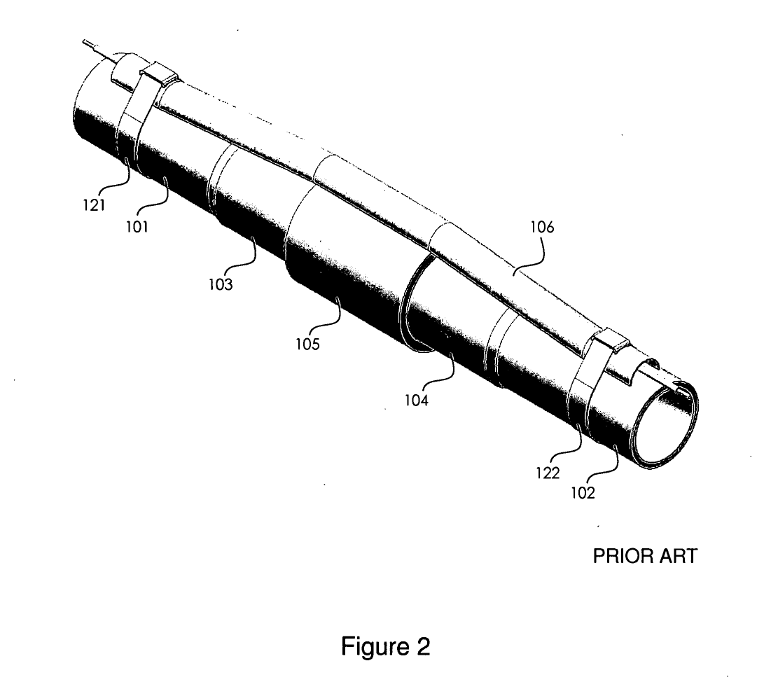

FIG. 2 illustrates the prior art cover 106. This cover is fabricated to span across the connection collar 105, over the production piping upsets 103, 104 and is fixed to the production tubing 101, 102 by bands 121, 122. The profile of the cover 106 is fabricated to match the diameters of the production piping 101, 102, and span the production piping upsets 103, 104 and the connector collar, 105. The profile of the fabricated cover is customized to fit over the lengths of the production pipe upsets 103, 104. The length of production pipe upsets can vary depending on the production tubing diameter and the number thread re-cuts. This requires further customization of the prior art cover dependent upon each pipe diameter and upset length.

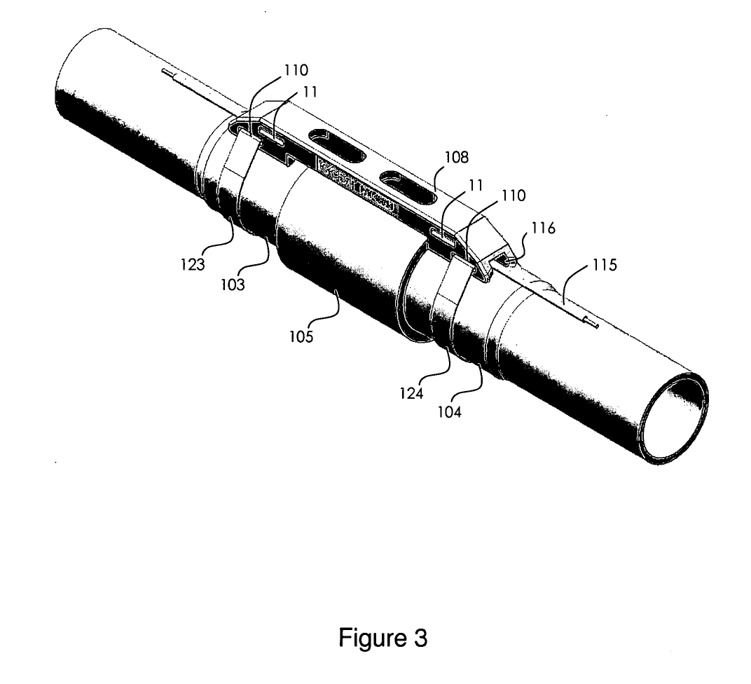

FIG. 3 illustrates the cover 108 installed on connection components. The cover is positioned spanning the connector collar 105 and rests on the upset sections 103, 104 of the production pipe, where the diameter is the greatest and contain the thickest walls. The cover is held in place with bands 123, 124 located through slots in the cover 110 or 111. Other slot arrangements are possible. The encircling band, threaded through a slot on each cover side, may also hold one or more tubes or cables.

Also illustrated in FIG. 3 is a length of jacketed tubing 115. The tubing passes through the open end 116 of the protective cover 108.

In addition, this specification is to be construed as illustrative only and is for the purpose of teaching those skilled in the art the manner of carrying out the invention. It is to be understood that the forms of the invention herein shown and described are to be taken as the presently preferred embodiments. As already stated, various changes may be made in the shape, size and arrangement of components or adjustments made in the steps of the method without departing from the scope of this invention. For example, equivalent elements may be substituted for those illustrated and described herein and certain features of the invention maybe utilized independently of the use of other features, all as would be apparent to one skilled in the art after having the benefit of this description of the invention.

While specific embodiments have been illustrated and described, numerous modifications are possible without departing from the spirit of the invention, and the scope of protection is only limited by the scope of the accompanying claims.

1. A protective cover comprising:
a) a cover comprised of metal;
b) the length of the cover is oriented parallel to the longitudinal axis of at least two pipe segments and a connector collar;
c) the cover comprises 2 sides and a top creating an interior channel;
d) the cover fits over the connector collar;
e) the cover rests on pipe upsets;

2. The protective cover of claim 1 further comprising attaching the cover with bands encircling the pipe upset.

3. The protective cover of claim 1 further comprising the cover dimensioned to convey at least one cable or tubing through the channel.

4. The protective cover of claim 1 further comprising cast metal.

5. The protective cover of claim 4 further comprising cast steel.

6. The protective cover of claim 2 further comprising a plurality of slots within the cover sides for placement of encircling bands.

7. The protective cover of claim 6 further comprising variably spaced slots to accommodate the encircling band and one or more tubes or cables.

8. The protective cover of claim 1 further comprising the encircling bands holding the cover and at least one cable or tube to the surface of the pipe upset.

9. The protective cover of claim 1 wherein the cover is attached by encircling bands at the connector collar.

10. The protective cover of claim 9 further comprising variable spaced or dimensioned slots on the cover sides to accept an encircling band.

11. The protective cover of claim 1 wherein the cover spans over the connector collar and extends to attach to each coupling end of the pipes.

12. The method of protecting tube or cable on the outer surface of a connector collar of a pipe comprising:
a) placing a cover over the tubing or cable;
b) placing the cover over a connector collar;
c) placing the cover on the connector collar so that a base of the cover rests on one or more pipe upsets; and
d) attaching the cover to the piping upsets with encircling bands.
